(19) United States
(12) Patent Application Publication
(10) Pub. No.: US 2024/0375773 A1
(43) Pub. Date: Nov. 14, 2024

(54) REMOVABLE T-DIVIDER

(71) Applicant: Airbus Operations GmbH, Hamburg (DE)

(72) Inventor: Boris Holtorf, Hamburg (DE)

(21) Appl. No.: 18/657,965

(22) Filed: May 8, 2024

(30) Foreign Application Priority Data
May 10, 2023 (EP) 23172583.9

(51) Int. Cl. B64D 11/00

(52) U.S. Cl. CPC B64D 11/0007

(57) ABSTRACT

A multi-slot compartment for a plurality of containers or trolleys includes a plate defining an upper limit of the compartment, wherein a removable T-divider is arranged at a lower surface of the plate so the T-divider separates spaces for the containers or trolleys. The removable T-divider includes at least one separating element and an operating element, the at least one separating element being coupled to the operating element and adapted to move from a first condition in which lateral movements of the containers are blocked to a second condition in which the containers are allowed to freely move beneath the plate.

### TECHNICAL FIELD

The disclosure herein relates to a multi-slot compartment for accommodating a plurality of movable containers like trolleys in an aircraft. In particular, the disclosure herein relates to preventing unintended side-movements of a trolley when being in such a multi-slot compartment.

### BACKGROUND

For example, in single aisle aircraft, it can happen that the outboard wall of a trolley compartment is located further outboard than the slide raft container or the door hinge of the closed entrance door. In consequence, the trolleys in such compartments cannot just be pulled straight out of their compartment but must be pulled out in an angle in order to get past the obstacles in the way.

Often, trolley slots are divided by T-dividers under a top plate or a workdeck so as to prevent tilting or turning of a trolley remaining inside a multi-slot compartment while the adjacent one of the trolleys is being outside of the compartment in use.

The T-divider keeps the remaining trolley(s) in that compartment in a straight position to facilitate insertion of a trolley after use or in an emergency case, e.g. in-flight turbulence.

EP 3 792 180 suggests the use of so-called “pivoting T-dividers” which are vertically hinged at a far end of the T-divider and can be shifted horizontally or sidewards at the front end so as to be at an angle under the workdeck. In other words, after temporary removal of an adjacent trolley, the front end of the “pivoting T-dividers” can be shifted sidewards to allow an angle in the trolley trajectory and, thus, the trolley can be moved along an inclined track past an obstacle. After trolley movement, the “pivoting T-dividers” must be shifted back by the user to the straight original position.

The use of a “pivoting T-divider” can be described by the following steps. (1) A locking mechanism at the T-divider has to be unlocked. (2) The user has to grab the pivoting T-divider under the workdeck and has to shift it from the straight into a sidewardly angled position. (3) The trolley can now be inserted into (or retrieved from) the compartment in an angled trajectory. (4) The user must again grab the pivoting T-divider under the workdeck and must push it back from the angled into the straight position. (5) The locking mechanism is to be locked again.

As the T-dividers extend under the workdeck they can be easily overlooked. Therefore, they can be easily hit by a trolley which can lead to damages to the T-divider. Moreover, there can be damages to the pivoting mechanism including hinges and guiding tracks due to wear, tear, vibration, misuse, abuse, and other reasons.

### SUMMARY

It may be seen as an object to provide a mechanism which is easier to use and which improves the movability of trolleys if needed. A solution is provided by the subject-matter and embodiments disclosed herein.

In general and in accordance with the disclosure herein, a T-divider for separating, e.g., containers or trolleys in a multi-slot compartment, comprises one or more separating element which can be moved from a first condition in which the separating element blocks sideward movement of a container, like a known T-divider, to a second condition in which the separating element does not block any movement of the container.

In the context of this disclosure, those separating elements are denoted as “removable T-divider”.

A removable T-divider according to an embodiment comprises at least one separating element and an operating element. The at least one separating element is coupled to the operating element and is adapted to move from a first condition to a second condition, wherein the at least one separating element is adapted to prevent movements of at least one of the containers, when the at least one separating element is in the first condition, and wherein the at least one separating element is adapted to allow movement of at least one of the containers, when the at least one separating element is in the second condition.

In the second condition, the T-divider can be said to be “removed”, meaning that any trolley can move transverse to the T-divider without contacting the same.

The removable T-divider may comprise a plurality of separating elements, wherein each of the plurality of separating elements is coupled to an operating element and is adapted to move simultaneously from the first condition to the second condition. That is, one operating element may move all separating elements.

According to an embodiment, the at least one separating element may be coupled to the operating element such that the operating element is translationally moving while the at least one separating element is rotationally moving. The operating element may, for example, be a rod provided with a first engagement element and the separating element may be pivotable about a horizontal rotation axis and may be provided with a second engagement element. It will be understood that the translational movement of the operating element may be transmitted by the engagement elements so as to cause the rotational movement of the separating element, or vice versa.

As an example, the first engagement element may be a protrusion and the second engagement element may be a recess, wherein the protrusion is configured to be received in the recess. Such a combination may be realized as gear drive.

According to another example, the first engagement element may be a lever and the second engagement element may be an engagement axis, wherein the engagement axis may be provided at the separating element at a distance to the rotation axis of the separating element and wherein the lever engages the engagement axis. This example may be denoted as crank mechanism.

Alternatively or additionally, the operating element may be coupled to the separating element at an engagement axis and a fixed abutment element may be provided adapted to cause a rotational movement of the separating element about the engagement axis. In other words, a translational movement of the operating element moves the separating element until a further translational movement of the separating element is blocked by the abutment element, which in turn causes a swiveling movement of the separating element.

According to another aspect, a multi-slot compartment for accommodating a plurality of containers is suggested, wherein the multi-slot compartment comprises a plate defining an upper limit of the multi-slot compartment, and a removable T-divider arranged at a lower surface of the plate so that the T-divider separates spaces for respective containers. The removable T-divider comprising at least one separating element and an operating element, wherein the at least one separating element is coupled to the operating element and is adapted to move from a first condition to a second condition, as described by the examples above.

The removable T-divider may be arranged at the plate such that an end portion of the operating element is located at an edge portion of the plate. Such an arrangement allows for an easy access and operation of the removable T-divider. The multi-slot compartment may comprise a plurality of removable T-dividers.

According to an embodiment, the multi-slot compartment may further comprise an extension element provided at the lower surface of the plate in extension of a longitudinal direction of the operating element, wherein the extension element is configured to separate spaces for respective containers. That extension element may be fixedly arranged.

Multi-slot compartments and removable T-dividers as described above can be used, in particular, in an aircraft.

### BRIEF DESCRIPTION OF THE DRAWINGS

Example embodiments of the disclosure herein will be described in the following with reference to the following drawings:

FIG. 1 schematically shows three stages of movement of a removable T-divider in a side view.

FIG. 2 is a schematical front view of a removable T-divider together with trolleys.

FIG. 3 is a schematical top view of the removable T-divider shown in FIG. 2.

FIG. 4 illustrates examples of engagement between operating element and separating element.

Certain embodiments will now be described in greater details with reference to the accompanying drawings. In the following description, like drawing reference numerals are used for like elements, even in different drawings. The matters defined in the description, such as detailed construction and elements, are provided to assist in a comprehensive understanding of the example embodiments. Also, well-known functions or constructions are not described in detail since they would obscure the embodiments with unnecessary detail. Moreover, expressions such as “at least one of”, when preceding a list of elements, modify the entire list of elements and do not modify the individual elements of the list.

### DETAILED DESCRIPTION

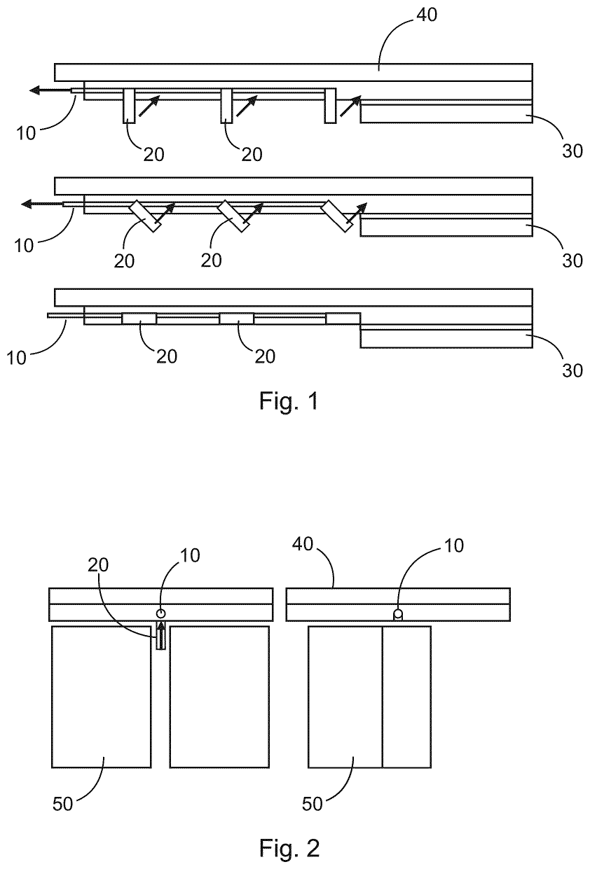

FIG. 1 shows an example removable T-divider with an operating element 10, three separating elements 20 and an extension element 30, all arranged under a plate 40. Further, FIG. 1 illustrates three stages of movement of the removable T-divider. From top to bottom, the separating elements 20 of the T-divider are shown (i) in a first condition in which movements of trolleys can be blocked, (ii) in an intermediate condition, and (iii) in a second condition in which the T-divider can be denoted as “removed”, i.e. in which a trolley may move beneath the separating elements 20. The direction of movement of the operating element as well as of the separating elements is indicated in FIG. 1 by arrows.

Instead of a T-extrusion with a vertical hinge point at the back and an angular guidance at the front, i.e. instead of a known “pivotable T-divider”, the proposed mechanism has a straight actuation by a rod-like operating element 10. The element may be connected with one or more rotatable separating elements 20 which provide local support for the trolley to prevent tilting or to transfer loads in lateral direction. A short piece of a fixed extension element 30 may be arranged at a portion (on the right in FIG. 1) where it does likely not impede trolley handling. When pulling the operating element 10 or when hit by a trolley from the front (from the left in FIG. 1), the operating element 10 will extend forward and the separating elements 20 will rotate backwards and upwards towards the workdeck. Then, the trolleys may be allowed to freely move inside the trolley compartment.

At the left side of FIG. 2, a front view is shown with two trolleys 50 beneath a plate 40, and with a removable T-divider with an operating element 10 and at least one separating element 20 between the trolleys. At the right side, one trolley 50 is located beneath the plate 40, wherein the trolley is oriented with an angle to the direction of the compartment. Here, the trolley may be freely moved under the plate 40, with the separating elements of the removable T-divider being in the second condition, i.e. not blocking such movements.

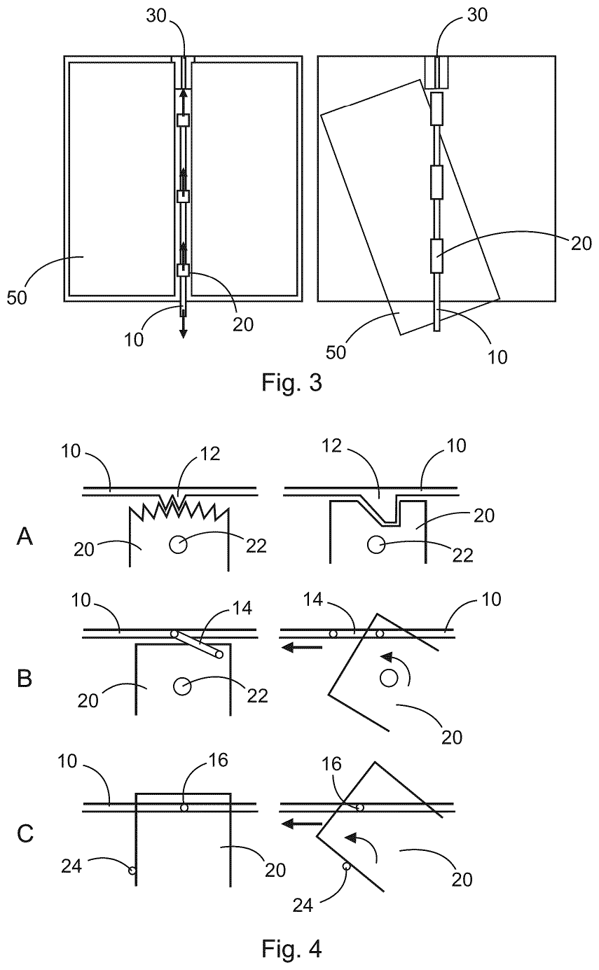

In FIG. 3, the situation as in FIG. 2 is shown by a top view. At the left side, the two trolleys 50 are shown inside their slots in the compartment, with the separating element(s) 20 lowered, i.e., in their first condition, so as to separate the two trolleys from each other. At the right side, the separating element(s) 20 are folded back and one trolley is removed. The remaining trolley 50 may, thus, be moved freely in the compartment, even crossing the line of the removable T-divider.

The function can further be described as follows. First, the mechanism may be considered in a condition which can be denoted as secured or safe status. The rod-like operating element is retracted and the rotatable separating element is lowered, providing local lateral support to the trolleys, i.e., the position of the trolleys are secured. In that situation, a handle at the front end of the operating element may be pulled by, e.g., the cabin crew so that the rod is moving forward and the rotatable element is retracting by rotating upwards and aft. In this status the rod may fully extend outward from the front of the workdeck. It may reach an end stop and may not be pulled any further. This position may be indicated as “unsafe” in a sense that a trolley beneath the workdeck is not secured with respect to lateral movements. The rotatable separating element may be fully removed so that it cannot be hit by a trolley anymore. The trolleys can freely move in their compartment now.

It is noted that a trolley may hit a rotatable separating element from the front during catering procedure. For example, it may have been forgotten to remove the separating elements out of the way. Being hit, the separating element rotates backwards out of the way of the trolley. As it is coupled with the rod, the rod moves forward.

In short, the following aspects and advantages can be mentioned with respect to the removable T-divider.

1.) The operating rod may have a front end which is easy to access so as to be pulled for removing the separating elements.

2.) The pulled rod may extend outwardly and an “unsafe” status may be indicated. The rod may have some kind of lock.

3.) There is no need to grab under the workdeck.

4.) The trolley can be inserted into (or retrieved from) the compartment in any angled trajectory as there is nothing protruding from underneath the workdeck.

5.) By pushing the operating rod back so as to lower the rotatable separating elements, a “safe” status can be restored. The rotatable elements will provide lateral support to the trolleys.

With respect to FIG. 4, examples are illustrated which allow a conversion of the translational movement of the operating element 10 to the rotational swivel movement of the separating element 20.

As example “A”, a tooth type gear is shown. The operating element 10 has at least one tooth 12 engaging into corresponding teeth or at least one recess at the end of the rotatable separating element. Operating forces at the operating element 10 cause the separating element 20 to rotate about the axis 22. Gravity extension at the separating element 20 may provide a tendency of the separating element towards the lowered first condition. Alternatively or additionally, spring elements may be provided which push or pull the separating elements and/or the operating element towards the first condition in which lateral movements of trolleys are prevented.

As example “B”, a hinge/lever type gear is shown. A lever 14 is attached to operating rod 10 and to the separating element 20 by rotation axes. Upon movement of the rod 10, the lever 14 will force the separating element 20 to follow. It may be understood that in case the lever axis at the separating element is arranged so as to be always behind (i.e., on the right side in FIG. 4) the rotation axis 22 of the separating element 20, gravity may cause the separating element to swivel back to the lowered first condition.

As example “C”, a resistance type gear is shown. There is any kind of physical resistance or abutment point 24 in the pull direction of the operating rod 10 next to the separating element 20 which is attached to the rod 10 by an axis 16. When pulling the operating rod 10, the point 24 will force the separating element 20 to a rotation. The further a sideward distance between rod 10 and abutment point 24, the less force is needed for operation.

While the disclosure herein has been illustrated and described in detail in the drawings and foregoing description, such illustration and description are to be considered illustrative or exemplary and not restrictive. The disclosure herein is not limited to the disclosed embodiments. Other variations to the disclosed embodiments can be understood and effected by those skilled in the art in practicing a claimed disclosure herein, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A removable T-divider for separating spaces in a multi-slot compartment for accommodating a plurality of containers, the T-divider comprising at least one separating element and an operating element,
wherein the at least one separating element is coupled to the operating element and is adapted to move from a first condition to a second condition,
wherein the at least one separating element is adapted to prevent transverse movements of at least one of the containers, when the at least one separating element is in the first condition, and wherein the at least one separating element is adapted to allow transverse movement of at least one of the containers, when the at least one separating element is in the second condition, and wherein the at least one separating element is removed in the second condition.

2. The removable T-divider of claim 1, wherein the T-divider comprises a plurality of separating elements, wherein each of the plurality of separating elements is coupled to the operating element and is adapted to move simultaneously from the first condition to the second condition.

3. The removable T-divider of claim 1, wherein the at least one separating element is coupled to the operating element such that the operating element is translationally moving while the at least one separating element is rotationally moving.

4. The removable T-divider of claim 3, wherein the operating element is a rod providing with a first engagement element and wherein the separating element is pivotable about a rotation axis and comprises a second engagement element.

5. The removable T-divider of claim 4, wherein the first engagement element is a protrusion and the second engagement element is a recess, wherein the protrusion is configured to be received in the recess.

6. The removable T-divider of claim 4, wherein the first engagement element is a lever and the second engagement element is an engagement axis, wherein the engagement axis is at the separating element at a distance to the rotation axis of the separating element and wherein the lever engages the engagement axis.

7. The removable T-divider of claim 3, wherein the operating element is coupled to the separating element at an engagement axis and wherein a fixed abutment element is adapted to cause a rotational movement of the separating element about the engagement axis.

8. A multi-slot compartment for accommodating a plurality of containers, wherein the multi-slot compartment comprises a plate defining an upper limit of the multi-slot compartment, and a removable T-divider arranged at a lower surface of the plate so that the T-divider separates spaces for respective containers, the removable T-divider comprising at least one separating element and an operating element,
wherein the at least one separating element is coupled to the operating element and is adapted to move from a first condition to a second condition,
wherein the at least one separating element is adapted to prevent transverse movements of at least one of the containers, when the at least one separating element is in the first condition, and wherein the at least one separating element is adapted to allow transverse movement of at least one of the containers, when the at least one separating element is in the second condition, and wherein the at least one separating element is removed in the second condition.

9. The multi-slot compartment of claim 8, wherein the removable T-divider is arranged at the plate such that an end portion of the operating element is located at an edge portion of the plate.

10. The multi-slot compartment of claim 8, wherein the multi-slot compartment comprises a plurality of removable T-dividers.

11. The multi-slot compartment of claim 8, further comprising an extension element provided at the lower surface of the plate in extension of a longitudinal direction of the operating element, wherein the extension element is configured to separate spaces for respective containers.

12. An aircraft comprising a multi-slot compartment for accommodating a plurality of containers according to claim 8, wherein the removable T-divider of the multi-slot compartment comprises at least one separating element and an operating element,
wherein the at least one separating element is coupled to the operating element and is adapted to move from a first condition to a second condition,
wherein the at least one separating element is adapted to prevent transverse movements of at least one of the containers, when the at least one separating element is in the first condition, and wherein the at least one separating element is adapted to allow transverse movement of at least one of the containers, when the at least one separating element is in the second condition, wherein the at least one separating element is removed in the second condition, and
wherein the T-divider comprises a plurality of separating elements, wherein each of the plurality of separating elements is coupled to the operating element and is adapted to move simultaneously from the first condition to the second condition.
